(19) United States
(12) Patent Application Publication
(10) Pub. No.: US 2009/0166564 A1
(43) Pub. Date: Jul. 2, 2009

(54) METHODS FOR MONITORING IMPLANTER PERFORMANCE

(76) Inventors: BENJAMIN G. MOSER, Chandler, AZ (US); John E. Wiggins, Royce City, TX (US); Jeffrey G. Loewecke, Wylle, TX (US); Alan L. Kordick, Allen, TX (US); Richard L. Guldi, Dallas, TX (US)

Correspondence Address: TEXAS INSTRUMENTS INCORPORATED, P O BOX 655474, M/S 3999, DALLAS, TX, 75265, US

(21) Appl. No.: 11/968,089

(22) Filed: Dec. 31, 2007

(51) Int. Cl. G21K 5/10

(52) U.S. Cl. 250/492.21

(57) ABSTRACT

Methods are presented to monitor the performance of an ion implanter such as the E500. Ion implantation typically involves physical processes performed on a wafer such as rotation, tilt, and twist. These methods generate particulate contaminants (PCs) that affect the kill rate of the semiconductor devices on the wafer. Variations in tilt angle also compromise dose accuracy. Presently, methods for testing for PCs and implant dose accuracy do not simulate actual manufacturing conditions. This invention discloses methods to test PC buildup using multiple wafers that are subjected to rotation, twist, tilt, and combinations thereof. Additionally, methods to test dose accuracy are presented, involving implanting a monitor wafer at an angle where the crystalline channel is aligned with the ion beam. Measuring sheet resistance as a function of tilt angle at this point ensures accurate tilt-angle calibration of the ion implanter.

### BACKGROUND OF THE INVENTION

1. Field of the Invention

The present invention relates generally to semiconductor fabrication. More particularly, the present invention relates to monitoring ion implantation procedures on wafers.

2. Background of the Invention

Semiconductor device construction is highly sensitive to particulate contamination. High current ion implantation is a significant source of particles that are generated from a variety of sources such as mechanical friction and lead rubbing. Additionally, small variations in the wafer tilt angle can cause errors in the implant angle, which leads to defective implantations. Implanters are regularly tested for defects by running monitor wafers through the implanter. These monitor wafers are tested for particulate contaminants (PCs), ion beam implant angle errors, and so on. However, current testing methods do not provide reliable results. Testing conditions often do not simulate realistic manufacturing conditions. Thus, improved methods for testing the efficacy of an ion implanter are needed.

Ion implantation is a surface modification process in which ions are injected into the near-surface region of a substrate. High-energy ions are produced in an accelerator and directed as a beam onto the surface of the substrate where they form an alloy with the surface upon impact. A typical ion-implanter used in many semiconductor fabrication plants today is the Varian E500 implanter. This type of implanter processes semiconductor wafers in batches, or “lots.” A single wafer is placed on a wafer holder, and an ion beam is aimed at the wafer. The wafer holder has the ability to rotate the wafer, and “tilt” the wafer around a horizontal axis normal to the incident angle of the ion beam (beam entry angle, or BEA). See FIG. 1 for details on the orientation of these movements. A single wafer holder may process a queue of multiple wafers, and a single ion implanter may process multiple wafer queues simultaneously.

The use of angled implants with wafer rotation, tilt, and twist has added new failure modes. One such failure mode is the generation of Particulate Contaminants (PC). Wafer rotation, tilt, and twist can introduce new PC generation mechanisms that must be quantified. These movements are a source of PC buildup on wafers. To rotate, the wafer holder sits on ball bearings. This mechanical movement causes friction and wearing/rubbing of parts. The ultra-clean vacuum environment within the implanter makes the wafers susceptible to particulate matter, dust, etc. generated by this friction. PCs lead to increased failure rate among components, and reduced overall yield. Additionally, at certain tilt angles, movement of mechanical parts around the wafer holder causes rubbing of parts against the walls of the chamber. In the E500 for instance, a phenomenon called “lead rubbing” involves rubber insulation around wires rubbing against the inner walls of the implanter. This releases more particles into the implanter environment, resulting in greater particulate contamination.

Another failure mode is caused by inaccurate dose placement. The tilt angle error is an important controlling variable affecting implant profile and dose placement. The reason is that in a crystallographic structure such as a silicone substrate or wafer, dopants and ions achieve depths of penetration that vary with the angle of the wafer. Small mechanical misalignments may cause dramatic variations in effective current/gate length, and may lower the yield, especially for advanced 65 and 45 nm technologies. Occasionally wafers are subjected to multiple operations on several machines. It is therefore very beneficial to ensure uniform calibration across these stations to increase overall yield.

There are several existing methods known in the art for testing production defects in an ion implanter. For instance, to detect PC contamination, a test wafer or monitor wafer is subjected to an ion implantation. Then, statistical process control (SPC) is used to detect abnormal or inconsistent PC counts on the monitor wafer. SPC involves using statistical techniques to measure and analyze the variation in processes. SPC comparison detects any unusual variation in the manufacturing process, which could indicate a problem with the process. However, current testing methods used for older implanter technologies are not effective in measuring PCs in present situations. It has been found that using one or two monitor wafers may show no signs of PC contamination, but processing large production lots of batches still leads to reduced yields due to contamination. Additionally, phenomena like lead rubbing are not adequately considered in present testing methods, which only test single wafers at small tilt angles between 0 and 7 degrees.

Furthermore, miscalibrations in the tilt angle of the wafer holder are not adequately compensated for in conventional testing methods. SPC is used to monitor dose accuracy after subjecting monitor wafers to tilt angles of only 0-7 degrees. Thus, what is needed is a method for testing implanters that simulates real-life conditions and provides measurable and quantifiable results.

### SUMMARY OF THE INVENTION

The present invention discloses methods for testing an ion implanter. Batches of wafers in an ion implanter are subjected to a series of mechanical operations characteristic of the implanting process. According to one exemplary embodiment, the present invention is a method involving subjecting a plurality of wafers to rotation, twist, and extreme tilt. Multiple wafers are used because testing only 1-2 monitor wafers tested by themselves would not yield realistic and measurable PC contamination because often times the efficacy of the implanter machines decreases with increased number of wafers used. Furthermore, extreme tilt and twist guarantee that lead rubbing and other phenomena inherent in an implanter are not ignored. Thus, the last few wafers from a batch subjected to rotation, extreme tilt, and twist may be used to monitor particles using SPC.

In another exemplary embodiment, monitor wafers are implanted immediately after processing a production lot subjected to rotation, tilt, and twist, loading the monitor wafers in a cassette position such that they are implanted after the production lot.

In another exemplary embodiment, instead of full production conditions, only extreme tilt is used. This can be used to isolate PC contamination to that generated from phenomenon like lead rubbing alone.

In an alternative exemplary embodiment, the present invention is a method for testing an ion implanter and correcting implanter profile, dose placement and accuracy. This can be achieved by monitoring minimum sheet resistance of the dosage area as a function of the tilt angle around a known crystallographic channel. The implanter setup is adjusted to minimize the sheet resistance. By defining this angle as the “standard qual angle”, the implanter setup angle accuracy can be statistically tracked. Thereby, monitoring sheet resistance at this known angle of high sensitivity allows one to calibrate all implanters to the same physical angle.

### BRIEF DESCRIPTION OF THE DRAWINGS

FIG. 1 shows the tilt and twist rotation axes of a wafer holder within a conventional ion implanter.

FIG. 2 shows a batch of wafers being processed within an ion implanter, according to an exemplary embodiment of the present invention.

FIG. 3 shows the effect of using multiple wafers to test PC contamination, according to an exemplary embodiment of the present invention.

FIG. 4 shows a chart describing the effects of increasing wafer count on faults detected, according to an exemplary embodiment of the present invention.

FIG. 5 shows how to calibrate the tilt angle, according to an exemplary embodiment of the present invention. FIG. 5A shows a close-up of an ion beam striking a wafer at the standard qual angle. FIG. 5B shows a crystallographic channel to explain the phenomenon. FIG. 5C shows how a silicon lattice structure presents channels when viewed from a particular angle.

### DETAILED DESCRIPTION OF THE INVENTION

The present invention discloses methods for testing an ion implanter by subjecting multiple wafers to rotation, twist, and tilt. A wafer holder within an ion implanter, such as the E500 implanter, processes a lot or batch of at least four wafers. Multiple wafers are used so that a measurable number of PCs can be generated. In one exemplary embodiment of the invention, any wafer beyond the first three wafers can be used as a monitor wafer. The wafer holder twists the wafer by rotating its surface in 90 degree increments. This ensures more accurate testing conditions because it produces PCs that will be generated by the friction of ball bearings within the rotation mechanism, thus simulating actual production conditions. The wafer holder also tilts the wafer to an extreme angle (at least 30 degrees) about its horizontal axis. It was found that large tilt angles on the E500 series cause “lead rubbing”, forcing a rubber insulated wire against the side wall of the implanter. This combination of physical movements generates sufficient PCs such that in a batch of 10 wafers, the 10^{th} wafer would have the highest PC levels. It was also found that a minimum of 4 wafers are required to be tested to detect measurable PC levels.

The present invention also addresses the issues relating to dose placement and accuracy. Around a specific implant tilt angle, in this case found to be around 36 degrees, a crystallographic channel within the silicon wafer is aligned with the implant beam. At this angle, the silicon crystal lattice structure provides minimum resistance to implant ions and dopants within the ion beam. Thus, dopants and impurities within the ion beam traverse deeper within the substrate. This lowers the sheet resistance at the surface of the wafer. Specifically, at a tilt angle of 36 degrees, sheet resistance is found to be at a minimum. Furthermore, at this angle, there is maximum sensitivity in sheet resistance to small variations in implant angle. This allows the wafer holder in an ion implanter to be calibrated to a more precise angle. Thus, it is an objective of an exemplary embodiment of the present invention to improve dose accuracy and placement by performing high-angle implants at 36 degrees, measuring sheet resistance, and correlating the sheet resistance to known configurations to accurately calibrate the tilt angle and consequently the beam angle.

For the purposes of the present invention, a “substrate” or “wafer” includes any thin slice of semiconducting material, such as a silicon crystal, upon which microcircuits are constructed by doping, chemical etching, and deposition. Substrates may undergo Shallow Trench Isolation (STI), Chemical-Mechanical Planarization (CMP), lithography, ion implantation, and other processes. A “lot” or “batch” of wafers comprises at least four wafers that are processed by an ion implanter within a short time span. At least four wafers will be required for a successful PC contamination test.

A “Monitor Wafer” or simply “monitor” is a wafer from the batch of wafers that is subjected to testing after undergoing an ion implantation process. According to an exemplary embodiment of the present invention, the monitor wafer is the last wafer in a batch of wafers. In another exemplary embodiment, the monitor wafer is at least the 4^{th} wafer in the batch, or any higher-numbered wafer. In yet another exemplary embodiment, the monitor wafer may be any wafer implanted immediately after a production batch of wafers such that it collects PCs from the production batch.

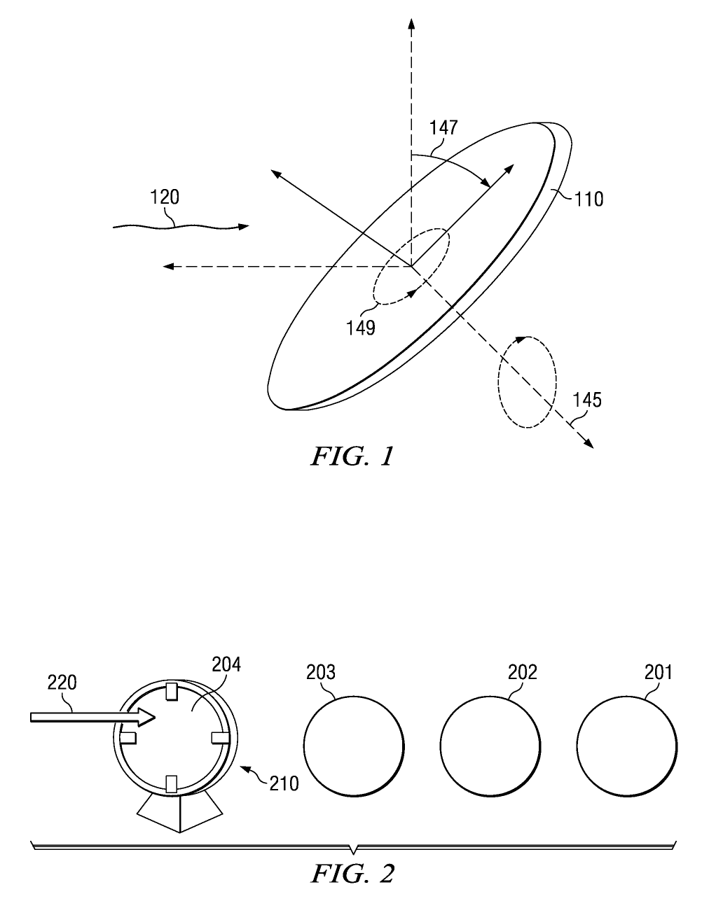

“Tilt” and “Twist” are physical movements applied to a wafer positioned in a wafer holder within an ion implanter. The respective orientations of these movements are shown in FIG. 1. Wafer holder 110 is tilted about its horizontal axis 145. The tilt angle away from the flat axis is represented by arrow 147. Wafers are again tilted to vary the angle of ion beam 120, consequently varying the depth and characteristics of implants such as resistance and gate length. A non zero tilt angle is used to avoid channeling effects in crystalline silicon, to introduce dopants into the sidewalls of a trench or to implant dopants underneath a mask edge by large tilt angle implants like large tilt angle implanted drain (LATID) or large tilt angle implanted punch-through stopper (LATIPS). As previously described, tilt causes “lead rubbing” which generates additional PCs. Lead rubbing is most clearly observed when tilt angle 147 is greater than thirty degrees. This angle of greater than thirty degrees may be referred to as “extreme tilt.” Additionally, a tilt angle of 36 degrees may be referred to as the “standard qual angle” for purposes of testing dose accuracy.

Additionally, the twist angle is helpful to completely describe the direction of incidence of the ion beam. Wafer holder 110 can also twist a wafer by rotating along the normal axis of the wafer. This rotation is shown by circle 149. In a typical E500 implanter, wafer holder 110 rotates over a rollerboard while positioned on ball bearings. The friction between the ball bearings and the rollerboard is one cause of PC generation. Wafers are twisted to vary the angle of the ion beam 120. The twisting mechanism causes additional stress on the ball bearings, increasing the rate of PC generation, and may also cause lead rubbing problems.

FIG. 2 shows a typical batch of wafers being processed within an ion implanter, according to an exemplary embodiment of the present invention. The batch of wafers comprises wafers 201-204, where wafer 204 is the fourth wafer to be processed. Wafer 204 is held by a wafer holder 210. Arrow 220 shows the trajectory of an ion beam within the implanter. Wafer holder 210 is capable of rotating wafer 204 by twisting and tilting the wafer such that ion beam 220 can strike wafer 204 at any desired part of the surface and at any angle. Additionally, rotation, twist and tilt cause PC buildup within the implanter. The use of at least four wafers 201-204 ensures that wafer 204 has adequate PC buildup to monitor, caused by PCs from processing wafers 201-203.

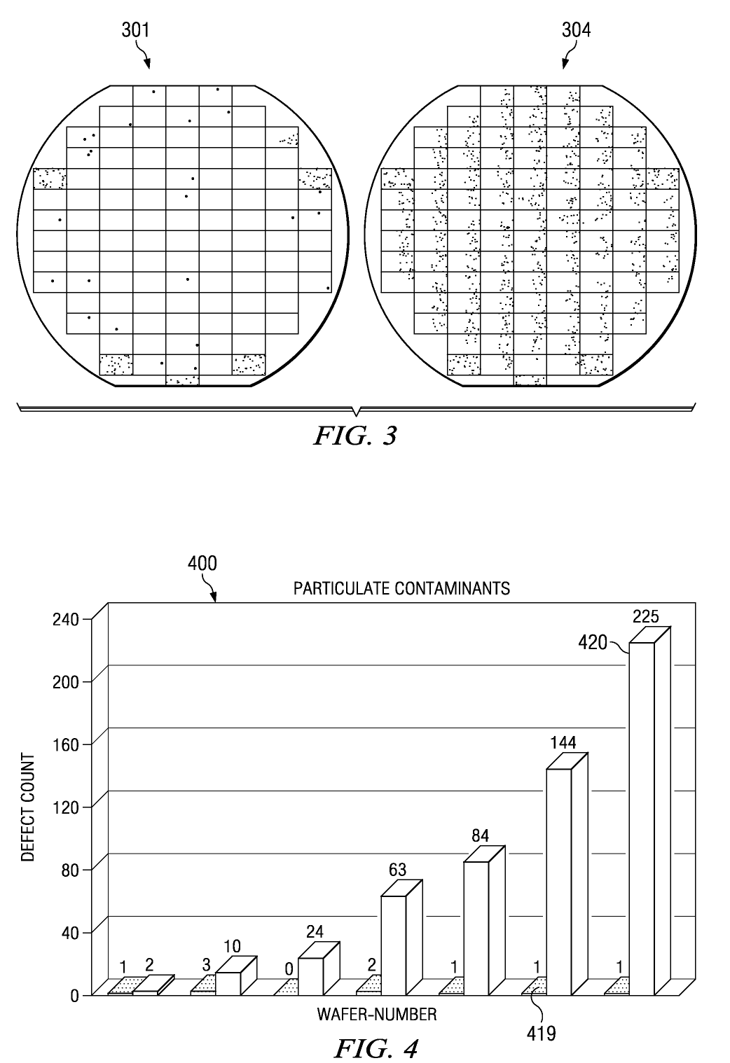

The effect of using multiple wafers is shown in FIG. 3. First wafer 301 undergoes an implantation process, and ends up with slight contamination by PCs, represented by the small dots. The implantation process may be a Light-Doped Drain (LDD) pattern. Wafer 304 shows a PC-contaminated wafer. Wafer 304 may be the fourth wafer or any higher numbered wafer from the batch of wafers. In this embodiment, at least three wafers undergo the implantation before wafer 304. Within the same batch of wafers, it is apparent that wafers four and beyond will have high PC levels. In the vacuum environment of the implanter, the short amount of time between batches of wafers allows PCs to be flushed away such that a subsequent batch is unaffected by PCs generated from a previous batch. Therefore it is very beneficial to use multiple wafers when testing for PC generation, rather than just one or two monitor wafers as is done in the field presently. Since higher PC levels lead to higher defects per wafer, it is most helpful to test PC generation using conditions as close as possible to real manufacturing conditions. Since modern implanters process large batches of wafers simultaneously, test wafers must also be processed in similar numbers.

FIG. 4 shows the effects of increasing wafer count on PC buildup, and subsequently, defects. Graph 400 shows the trend of defect counts observed on 7-wafer pilot runs, according to an exemplary embodiment of the present invention. The x-axis represents the wafer number within the batch of wafers. The y-axis represents the number of defects measured. Two data sets are presented: the steadily low set of points 419 is the result of a test run involving no tilt or twist. The second set of points 420 is the result of a test run involving some amount of both tilt and twist. This set of points gets steadily higher with the wafer count.

The graph shows that a single pilot test is insufficient to cause PCs; rather, multiple wafer implants are required to cause measurable buildup. Additionally, since implant self-cleaning occurs fairly quickly (within less than two batches of wafers), it is difficult to diagnose the situation without using multiple wafers. Finally, it is apparent that tilt or twist is required for PC generation. Thus, some combination of rotation, tilt, twist, along with multiple wafers is required to achieve measurable PC buildup.

In an alternative exemplary embodiment, monitor wafers are implanted immediately after a production lot undergoing these processes. The production lot uses twist rotation and extreme tilt. The monitor wafer(s) should be implanted immediately after the production lot. This ensures PC buildup from the production lot affects the monitor wafer as it would affect wafers within the production lot.

As described herein, another problem addressed by the present invention relates to the implant dose accuracy. In one exemplary embodiment, the present invention improves implant profile and calibration of dose placement. This is achieved by monitoring sheet resistance as a function of tilt angle for a monitor wafer around a known crystallographic channel, and adjusting the implanter setup to minimize sheet resistance. Furthermore, by selecting one angle near or in the crystallographic channel as the “standard qual angle”, the implanter setup angle accuracy can be statistically tracked. This allows one to monitor changes in sheet resistance at an angle of maximum sensitivity, thus allowing all implanters to be calibrated to the same physical angle. The same monitor wafer may be used for both PC checking and dose accuracy. After undergoing SPC for PC contamination, the wafer may be annealed, thus activating the electric components. Sheet resistance is then tested. This serves to prevent waste of wafers while minimizing experimental runs.

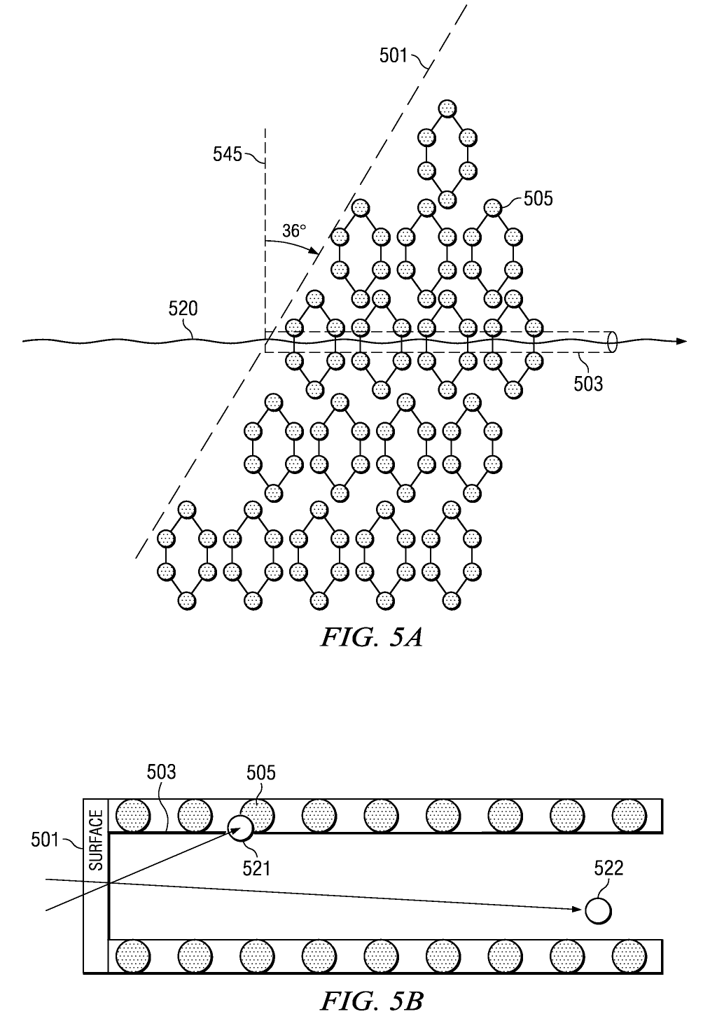

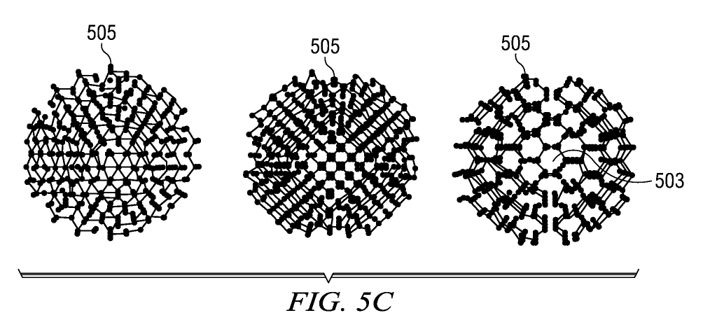

FIG. 5A shows a close-up of an ion beam striking a wafer at the standard qual angle of 36 degrees. Wafer 501 is tilted to an angle of 36 degrees from the default flat position 545. Ion beam 520 enters wafer 501, and the tilt angle is such that the ion beam 520 traverses directly through a channel 503. As described before, the depth of an implant varies immensely with small changes in angle close to this standard qual angle. Thus, since particles in beam 520 have a much smaller chance of encountering silicon atoms 505, the dopant profile is significantly deeper than it would be for any other angle around the standard qual angle.

FIG. 5B zooms into this crystallographic channel to further explain the phenomenon. Dopant 521 enters crystallographic channel 503 at an angle that is not the standard qual angle. Since dopant 521 is not aligned with channel 503, it encounters a silicon atom 505 and ends up closer to the surface 501 of the substrate. On the other hand, dopant 522 enters channel 503 at an angle close to the standard qual angle. Since it is in alignment with channel 503, dopant 522 ends up traversing deeper into the wafer, resulting in a deeper implant profile. When the wafer is annealed and made electrically active, sheet resistance is measured. Close to the standard qual angle, sheet resistance is lowest because implant profiles are deep.

FIG. 5C shows how a silicon lattice structure presents channels when viewed from a particular angle. Silicon atoms 505 form a lattice structure that opens up to create channels 503 when viewed from a specific angle. According to an embodiment of the present invention, this angle is achieved when the substrate is tilted to 36 degrees away from the incident beam angle.

In one exemplary embodiment, after implantation, the monitor wafer is annealed and then checked for resistivity. After implantation, the wafer is placed in an annealer, such that the dopant material interacts with the crystalline structure making it electrically active. Sheet resistance is then tested to determine a minimum value or to compare to a known minimum value. The tool can thus be recalibrated to match minimum resistance at the standard qual angle.

The advantages of this process are numerous. For one, the disclosed method assures accurate particle monitoring, allowing for higher standards. Complying with the standards saves costs of end-of-line fault analysis and diagnoses. Additionally, this method reduces the number of pilot runs, and can be applied to multiple existing and future technologies undergoing rotation and twist implants. Since multiple implanters including the entire E500 series are subject to the problems from lead rubbing, this method would work on these devices, reducing the risks of lot scrapping. Furthermore, since newer implanters are more accurate, older implanters are able to be reprogrammed to match the accuracy of the new implanters using the standard qual angle check.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for testing an ion implanter, comprising:
tilting a wafer holder such that an ion beam having an incident beam angle reaches a wafer on the wafer holder at an angle of at least thirty degrees from the normal of the incident beam angle; and
subjecting the wafer to a statistical process control.

2. The method of claim 1, wherein the wafer is one of a batch of at least four wafers.

3. The method of claim 2, wherein the wafer is the fourth wafer or any higher numbered wafer from the batch of at least four wafers.

4. The method of claim 1, further comprising:
tilting the wafer holder to a 36 degree angle relative to the incident beam angle; and
measuring the sheet resistance of the wafer.

5. The method of claim 1, further comprising:
subjecting the wafer holder to a twist rotation.

6. A method for detecting particulate contaminants in an ion implanter, comprising:
providing a batch of wafers to the ion implanter;
subjecting the batch of wafers to a tilt rotation; and
detecting particulate contaminants on a single wafer selected from the batch of wafers.

7. The method of claim 6, wherein the batch of wafers comprises at least four wafers.

8. The method of claim 7, wherein the wafer is the fourth wafer or any higher numbered wafer from the batch of at least four wafers.

9. The method of claim 6, further comprising:
tilting the batch of wafers to a 36 degree angle relative to an incident beam angle; and
measuring the sheet resistance of the wafer.

10. The method of claim 6, further comprising:
subjecting the batch of wafers to a twist rotation.

11. A method for detecting particulate contaminants on a wafer, comprising:
introducing a batch of wafers to an ion implanter, wherein the batch of wafers comprises at least four wafers;
subjecting the batch of wafers to a twist rotation; and
detecting particulate contaminants on a single wafer selected from the batch of wafers, wherein the single wafer may not be selected from the first three wafers.

12. The method of claim 11, further comprising:
tilting the batch of wafers to a 36 degree angle relative to an incident beam angle; and
measuring the sheet resistance of the batch of wafers.

13. A method for ensuring accurate detection of particulate contaminants on a wafer, comprising:
placing a first wafer on a wafer holder within an ion implanter;
subjecting the wafer to an ion implantation process; wherein the ion implantation process comprises tilting the wafer holder to an angle of at least 30 degrees away from the normal of the incident angle of an ion beam; and
subjecting a second, a third, and a fourth wafer to the ion implantation process; wherein the fourth wafer is tested for particulate contamination.

14. The method of claim 13, further comprising:
subjecting multiple wafers to the ion implantation process; and
testing the last wafer for particulate contamination.

15. The method of claim 13, wherein the testing for particulate contamination comprises statistical process control.

16. A method for calibrating the tilt angle of an ion implanter, comprising:
providing a wafer within the ion implanter;
tilting the wafer to an angle of at least 36 degrees from the normal of an incident angle of an ion beam within the ion implanter;
doping the wafer with the ion beam;
annealing the wafer; and
measuring the sheet resistance of the wafer, wherein the lowest sheet resistance value corresponds to a standard qual angle.

17. The method of claim 16, wherein the standard qual angle is the angle at which the ion beam would be parallel to a known crystalline channel within the wafer on a properly calibrated ion implanter.

18. The method of claim 16, wherein the doping step occurs by introduction of a dopant within a channel within the wafer.

19. The method of claim 18, wherein the dopant is introduced deeper in the channel than would be introduced if the tilt angle was not 36 degrees.

20. The method of claim 18, wherein the dopant is electrically active.
